(19) United States
(12) Patent Application Publication
(10) Pub. No.: US 2015/0234963 A1
(43) Pub. Date: Aug. 20, 2015

(54) INTERFACE ANALYSIS FOR VERIFICATION OF DIGITAL CIRCUITS

(71) Applicant: NVIDIA CORPORATION, Santa Clara, CA (US)

(72) Inventors: David Lyndell BROWN, Austin, TX (US); Yi ZHANG, Shanghai (CN)

(73) Assignee: NVIDIA CORPORATION, Santa Clara, CA (US)

(21) Appl. No.: 14/182,626

(22) Filed: Feb. 18, 2014

(51) Int. Cl. G06F 17/50

(52) U.S. Cl. CPC G06F 17/5045

(57) ABSTRACT

A method for performing an interface analysis. The method includes identifying a first module included in a representation of a digital circuit. The method also includes identifying a first output port associated with the first module. The method further includes identifying a first logic path that extends from the first output port. The method also includes determining that the first logic path extends to a first storage element included in the first module. The method further includes including the first module, the first output port, the first logic path, and the first storage element in interface logic output data.

### BACKGROUND OF THE INVENTION

1. Field of the Invention

Embodiments of the present invention relate generally to verifying computer designs and, more specifically, to an interface analysis for verifying digital circuits.

2. Description of the Related Art

The development process for digital microchips includes many different stages, including conception, design, and testing. In one stage, termed “formal verification,” a formal verifier tests a working microchip representation that includes logic gates and storage elements against a microchip representation standard. The microchip representation standard (referred to herein as “the standard” or “the standard model”), which is a model that has been previously designed and tested by a digital circuit designer, includes a collection of logic gates and storage elements connected together to produce a particular functionality dictated by design specifications. The working microchip representation (referred to herein as “the working model”) represents a modified version of the standard. The modifications included in the working model relative to the standard may be made for several reasons, such as to improve timing or power consumption.

In some situations, such as when the microchip includes a very large number of logic gates, the entire working microchip representation is not verified against the entire standard at the same time. Instead, the working microchip representation and the standard are divided into modules. Each module includes internal logic as well as interface logic that describes connections between modules. Both the internal logic and the interface logic are verified during formal verification. More specifically, a formal logic verification tool compares both the internal logic and interface logic of the modules in the working model with the internal logic and interface logic of corresponding modules in the standard model. If the internal logic and interface logic in both the working model module and in the corresponding standard module are functionally the same, then the formal verification is deemed to pass.

Some modifications made to a working model primarily affect interface logic, as opposed to internal logic. These modifications may, for example, cause paths that flow from a storage element in a first module, through a second module, to a storage element in a third module, to instead flow from the storage element in the first module, through a fourth module, and to the storage element in the third module. Other similar types of modifications may be made as well. Ideally, formal verification is able to robustly handle modifications of this type without providing false negatives. False negatives are “failures” of the test performed by the formal verification tool despite the working model and standard being functionality equivalent. The ability to robustly handle modifications is dependent on the manner in which the interface logic is defined.

In one technique, interface logic is defined simply as the identities of the ports included in each module, where ports describe the connections between the modules. One drawback of this technique, however, is that this definition is susceptible to false negatives in certain situations. For example, if, as described above, a path that flows from a first module, through a second module, to a third module, is modified to instead flow from the first module, through a fourth module, to the third module, then a formal verification tool that verifies port-only interface logic would report a false negative, as the third module and fourth module have different ports in the working model and the and the standard model. False negatives are detrimental to the development process, because false negatives may require additional verification steps to be conducted to determine that the reported negatives are false.

Other techniques define interface logic as including a large amount of information about logic gates, timing, and other information, in addition to just information about ports. One drawback of these other techniques, however, is that formally verifying large amounts of information takes much more time.

Accordingly, what is needed in the art are more robust techniques for analyzing interface logic.

### SUMMARY OF THE INVENTION

Embodiments set forth herein include a method for performing an interface analysis. The method includes identifying a first module included in a representation of a digital circuit. The method also includes identifying a first output port associated with the first module. The method further includes identifying a first logic path that extends from the first output port. The method also includes determining that the first logic path extends to a first storage element included in the first module. The method further includes including the first module, the first output port, the first logic path, and the first storage element in interface logic output data. Embodiments set forth herein also include a system and a computer-readable medium for performing an interface analysis.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 illustrates a microchip representation standard for conducting interface analysis, according to one embodiment of the present invention;

FIG. 3 illustrates a working microchip representation for conducting interface analysis, according to one embodiment of the present invention; and

FIG. 4 is a flow diagram of method steps for performing interface analysis, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

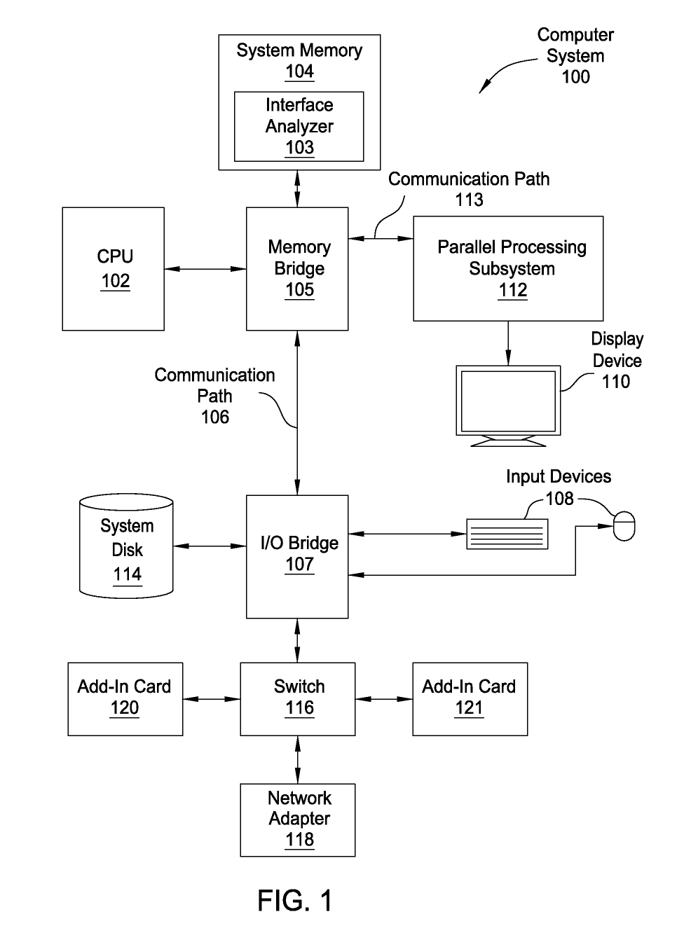

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

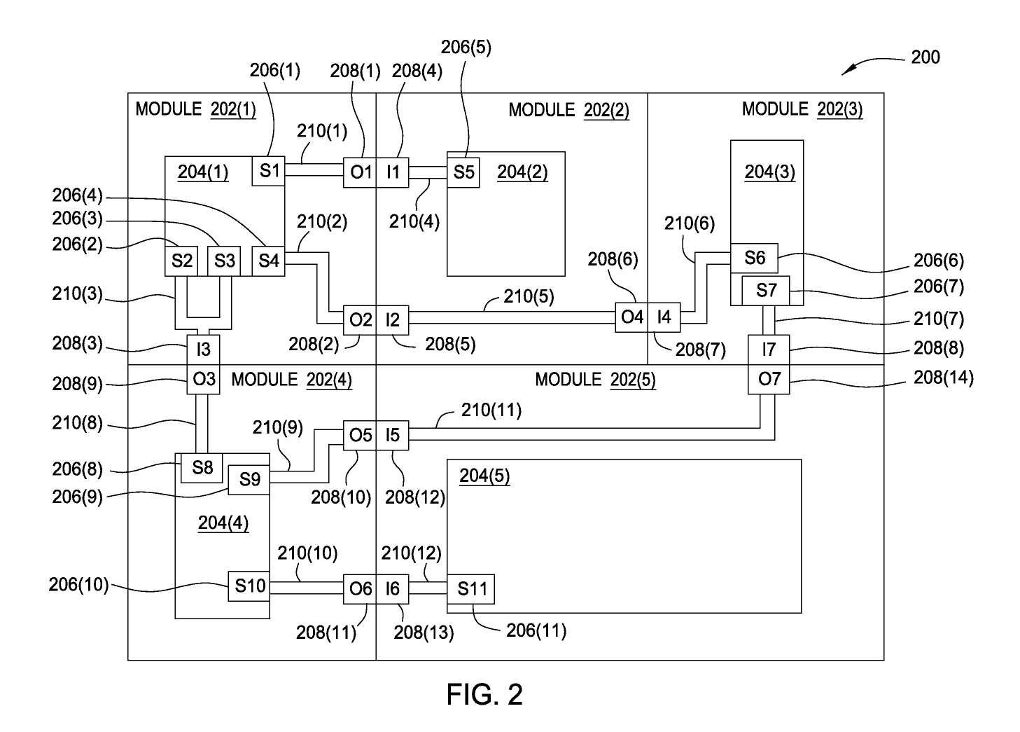

In some embodiments, parallel processing subsystem 112 is part of a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes an interface analyzer 103 configured to analyze representations of a digital circuit as described in more detail below.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

### Interface Analysis for Verification of Digital Circuits

As described above, several techniques currently exist for performing verification analysis on microchip designs. Generally, these techniques test a working microchip representation that includes logic gates and storage elements against a microchip representation standard. The microchip representation standard (referred to herein as “the standard” or “the standard model”), which is a model that has been previously designed and tested by a digital circuit designer, includes a collection of logic gates and storage elements connected together to produce a particular functionality dictated by design specifications. The working microchip representation (referred to herein as “the working model”) represents a modified version of the standard. The modifications included in the working model relative to the standard may be made for several reasons, such as to improve timing or power consumption.

As also described above, in some situations, such as when the microchip includes a very large number of logic gates, the entire working microchip representation is not verified against the entire standard at the same time. Instead, the working microchip representation and the standard are divided into modules. Each module includes internal logic as well as interface logic that describes connections between modules. Both the internal logic and the interface logic are verified during formal verification.

However, many of the techniques for performing verification analysis on interface logic are not robust in that these techniques suffer from false negatives. A more robust manner in which to perform interface analysis is detailed below with respect to FIGS. 2-4. More specifically, FIGS. 2-4 provide techniques for analyzing a microchip representation that is divided into modules to determine what portions of the microchip representation belong in an “interface logic output” that describes interface logic for a particular microchip representation.

FIG. 2 illustrates a microchip representation standard 200 for conducting interface analysis, according to one embodiment of the present invention. An analyzer module, such as interface analyzer 103 of FIG. 1, may conduct interface analysis with the microchip representation standard 200. As shown, the microchip representation standard (“standard model”) 200 includes modules 202, each of which includes internal logic 204, ports 208, storage elements 206, and logic paths 210.

More specifically, microchip representation 200 is divided into a number of modules 202. Each module 202 includes internal logic 204. Internal logic 204 represents storage elements and logic gates within each module 202 that are internal to each module 202. Storage elements 206 at the external border of internal logic 204 are coupled to logic paths 210, which are coupled to ports 208. Storage elements 206 and logic gates that are internal to internal logic 204 are not depicted in FIG. 2.

Each module also includes border logic, which includes ports 208, which may be either input or output ports, and logic paths 210 coupled to ports 208. Border logic also includes storage elements 206 within internal logic 204 that are coupled, through logic paths 210, to ports 208. Storage elements 206 that are internal to internal logic 204 are not included in border logic. Storage elements 206 are internal to internal logic 204 if an intervening storage element is present between such storage elements 206 and a port 208. For example, a storage element 206 that is coupled, through logic gates (or directly) to another storage element 206, but not to a port 208, is considered internal to internal logic 204.

Logic paths 210 represent logic gates, or simply wired connections with no logic gates, that are present between storage elements 206 within border logic and ports 208, and may include any number of various types of logic gates.

Ports 206 represent data connections between modules 202. An output port is a port 206 through which data leaves the module 202 in which the output port is located. An input port is a port 206 through which data enters the module 202 in which the input port is located. Input ports on any particular module 202 are coupled to output ports on another module 202.

In the example microchip representation standard 200 illustrated in FIG. 2, 5 modules 202 are depicted. Module 202(1) includes internal logic 204(1), which includes storage element 206(1), storage element 206(2), storage element 206(3), and storage element 206(4). Module 202(1) also includes logic path 210(1), logic path 210(2), and logic path 210(3). Module 202(1) further includes port 208(1), which is an output port, port 208(2), which is also an output port, and port 208(3), which is an input port. Module 202(1) also includes logic path 210(1), logic path 210(2), and logic path 210(3). Logic path 210(1) couples storage element 206(1) to output port 208(1). Logic path 210(2) couples storage element 206(4) to output port 208(2). Logic path 210(3) couples both storage element 206(2) and storage element 206(3) to input port 208(3).

Module 202(2) includes internal logic 204(2), which includes storage element 206(5). Module 202(2) also includes logic path 210(4) and logic path 210(5). Module 202(2) further includes port 208(4), which is an input port, port 208(5), which is also an input port, and port 208(6), which is an output port. Input port 208(4) is coupled to output port 208(1) and input port 208(5) is coupled to output port 208(2). Module 202(2) also includes logic path 210(4) and logic path 210(5). Logic path 210(4) couples storage element 204(5) to input port 208(4). Logic path 210(5) couples input port 208(5) to output port 208(6).

Module 202(3) includes internal logic 204(3), which includes storage element 206(6) and storage element 206(7). Module 202(3) further includes port 208(7), which is an input port, and port 208(8), which is also an input port 208(8). Input port 208(7) is coupled to output port 208(6). Module 202(3) also includes logic path 210(6) and logic path 210(7). Logic path 210(6) couples storage element 206(6) to input port 208(7) and logic path 210(7) couples storage element 206(7) to input port 208(8).

Module 202(4) includes internal logic 204(4), which includes storage element 206(8), storage element 206(9), and storage element 206(10). Module 202(4) further includes port 208(9), which is an output port, port 208(10), which is an output port, and 208(11), which is an output port. Output port 208(9) is coupled to input port 208(3). Module 202(4) also includes logic path 210(8), logic path 210(9), and logic path 210(10). Logic path 210(8) couples output port 208(9) to storage element 206(8). Logic path 210(9) couples output port 208(10) to storage element 206(9). Logic path 210(10) couples storage element 206(10) to output port 208(11).

Module 202(5) includes internal logic 204(5), which includes storage element 206(11). Module 202(5) further includes port 208(12), which is an input port, port 208(13), which is also an input port, and port 208(14), which is an output port. Input port 208(12) is coupled to output port 208(10). Input port 208(13) is coupled to output port 208(11). Output port 208(14) is coupled to input port 208(8). Module 202(5) also includes logic path 210(11) and logic path 210(12). Logic path 210(11) couples input port 208(12) to output port 208(14). Logic path 210(12) couples storage element 206(11) to input port 208(13).

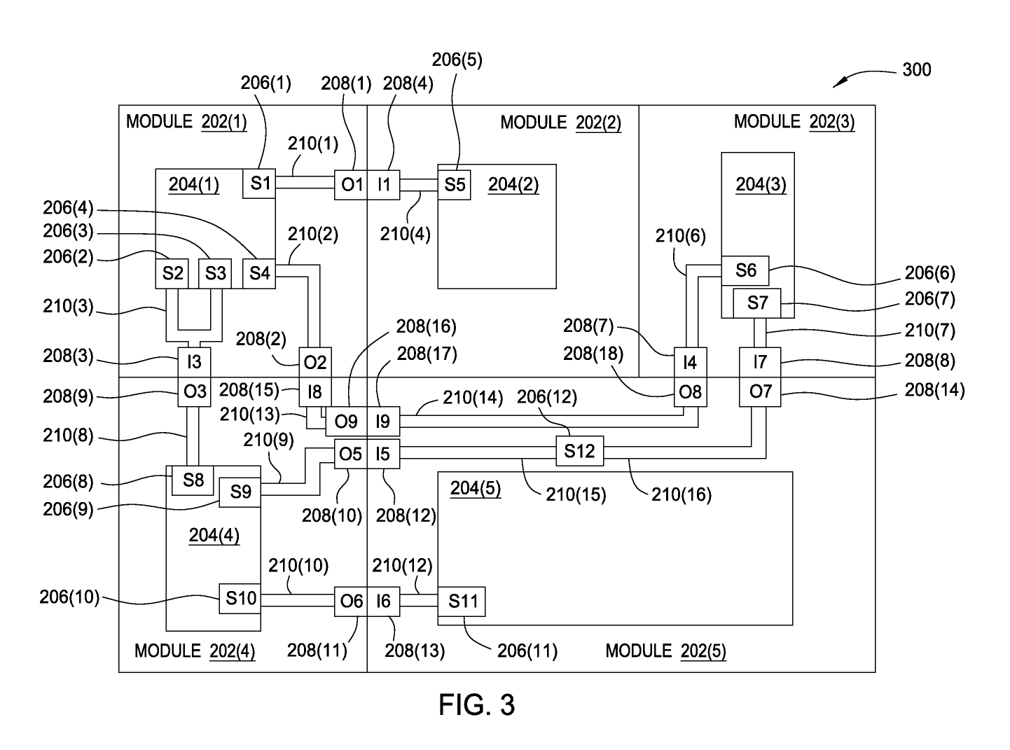

FIG. 3 illustrates a working microchip representation 300 for conducting interface analysis, according to one embodiment of the present invention. An analyzer module, such as interface analyzer 103 of FIG. 1, may conduct interface analysis with the working microchip representation 300. As shown, the working microchip representation (“working model”) 300 includes modules 202, each of which includes internal logic 204, ports 208, storage elements 206, and logic paths 210.

The working model 300 is similar to the standard model 200 except that a designer has adjusted the path between storage element 206(4) and storage element 206(6) from traversing module 202(2) to instead traversing module 202(4) and module 202(5). This adjustment involves removing input port 208(5) and output port 208(6) from module 202(2). This adjustment also involves adding input port 208(15) and output port 208(16) to module 202(4) and adding input port 208(17) and output port 208(18) to module 202(5). The adjustment further involves removing logic path 210(5) from module 202(2), adding logic path 210(13) to module 202(4), and adding logic path 210(14) to module 202(5). The adjustment also involves adding storage element 206(12) and replacing logic path 210(11) with logic path 210(15) and logic path 210(16).

Referring to FIGS. 2 and 3 together, interface analysis is performed on the standard model 200 and the working model 300 to generate an interface logic output for each of the standard model 200 and the working model 300. Another analysis tool may then compare the interface logic output from both the standard model 200 and the working model 300 to determine whether the interface logic for both the standard model 200 and the working model 300 are functionally the same.

To generate the interface logic output, the interface analyzer 103 performs interface analysis on each module 202 in both the standard model 200 and the working model 300 in isolation. The isolation allows the interface analysis for all modules to be performed simultaneously. Generally speaking, to perform interface analysis, interface analyzer 103 examines each module 202 and extracts ports 208, logic paths 210, and storage elements 206 that interface analyzer 103 deems to be included in interface logic output for the module 202, and generates an interface logic output based on these extracted elements. In one embodiment, the interface logic output is a gate-level netlist that includes the ports 208, logic paths 210, and storage elements 206 deemed to be included in the interface logic. A gate-level netlist is a description of the logic gates and storage elements and the connectivity between such logic gates and storage elements that are included in a particular digital circuit or portion of a digital circuit, as is generally known in the art.

The interface analyzer 103 (FIG. 1) may operate in several different modes of operation in order to generate the interface logic output. In a first mode of operation, the “basic mode,” the interface logic output includes all ports 208 in a module, all logic paths 210 that are coupled to output ports 208, and all storage elements coupled to output ports 208 through the logic paths 210 in the interface logic output. However, the interface analyzer 103 does not include in the interface logic output logic paths 210 that are coupled between storage elements 206 and input ports 208, or any logic gates or storage elements within internal logic 204 except for the storage elements 206 that are coupled to output ports 208 through logic paths 210 as described above. In a second mode of operation, the “retiming mode,” the interface analyzer 103 includes all elements that would be included by the basic mode in the interface logic output, and in addition, “retiming registers,” which are described in more detail below. In a third mode of operation, the “extended input logic mode,” the interface analyzer 103 includes all elements that would be included by the basic mode in the interface logic output, but also includes at least some of the logic paths 210 between input ports 208 and storage elements 206 as well, as described in further detail below.

In a fourth mode of operation, the “power-gate clamp include mode,” the interface analyzer 103 includes all elements that would be included by the basic mode in the interface logic output, and also recognizes portions of logic paths 210 that are coupled to input ports 208 and that perform power-gate clamping functions and includes those logic paths 210 in the interface logic output. These logic paths 210 ensure stable voltage levels when electrical signals from a module that is power-gated (i.e. powered off) connects via a module that may be powered on. For example, a path from the first module 202(1) in FIG. 2, going through the second module 202(2) and ending in the third module 202(3) would require a power-gate clamp in the second module 202(2), if the second module includes a region that could be powered-on while the first module is powered off. Because clamping requirements depend on how modules are connected through different regions of power, and these pathways are often altered to improve timing in the working model, the fourth mode of operation includes these clamping elements, so that the clamping elements may be verified as part of the interface logic output. In a fifth mode of operation, the “demerge storage elements mode,” the interface analyzer 103 recognizes storage elements 206 that have been merged, demerges those storage elements 206, and includes the demerged storage elements 206 in the interface logic output. Any of the second mode, the third mode, the fourth mode, and the fifth mode may be combined. For example, with the second and third modes combined, the interface analyzer 103 includes all of the elements in the basic mode, and also includes retiming registers in the interface logic output, and also does include at least some of the logic paths 210 between input ports 208 and storage elements 206 as in the extended input logic mode.

These modes of operation are now described in more detail. In the basic mode, to perform interface analysis, interface analyzer 103 locates ports 208 associated with the module 202. Interface analyzer 103 identifies each located port as either an input port 208 or an output port 208. If the port 208 is an input port 208, then the interface analyzer 103 notes the identity of that input port 208 and does not perform any analysis of any logic paths 210 within that module 202 that are coupled to that input port 208. If, on the other hand, the port 208 is an output port 208, then the interface analyzer 103 traces through a logic path 210 coupled to the output port 208.

If the interface analyzer 103 arrives at a storage element 206, then the interface analyzer 103 records all information including the identity of the output port 208, a gate-level netlist for the logic path 210, and the identity of the storage element 206 at which the interface analyzer 103 arrives and stores this information in the interface logic output. The interface analyzer 103 does not analyze any logic gates past the identified storage element 206 and therefore does not include such logic gates in the interface logic output.

If, while tracing back from the output port 208, the interface analyzer 103 does not arrive at a storage element 206, but instead arrives at an input port 208, then the interface analyzer 103 notes the analyzed output port 208, the input port 208 arrived at, and the logic path 210 between the output port 208 and the input port 208 and stores the output port 208, input port 208 arrived at, and logic path in the interface logic output.

In one embodiment, the interface analyzer 103 performs the analysis described above for each output ports 208 in a module 202 and stores resulting information in the interface logic output. The resulting information includes an identification of all input ports 208 in the module 202, all output ports 208 in the module 202, all logic paths 210 between output ports 208 and storage elements 206, and all logic paths 210 between any input ports 208 and output ports 208 that do not have intervening storage elements 206. As described above, in the basic mode, interface analyzer 103 does not identify logic paths 210 from input ports 208 to storage elements 206 or store these logic paths 210 in interface logic output.

Interface analysis is now described with reference to the example standard model 200 depicted in FIG. 2. For module 202(1), interface analyzer 103 identifies port 208(1) as an output port and identifies port 208(2) as an output port. Interface analyzer 103 also identifies the logic path 210(1) between port 208(1) and storage element 206(1), as well as logic path 210(2) between port 208(2) and storage element 206(4). Interface analyzer 103 also identifies port 208(3) as an input port and therefore does not analyze logic path 210(3), storage element 206(2), or storage element 206(3). Interface analyzer 103 stores all the identified elements, including storage element 206(1), logic path 210(1), storage element 206(4), logic path 210(2), output port 208(1), output port 208(2), and input port 208(3), in interface logic output. Interface analyzer 103 also stores the connectivity of these elements in the interface logic output.

For module 202(2), interface analyzer 103 identifies output port 208(6), and that logic path 210(5) connects output port 208(6) to input port 208(5). Interface analyzer 103 also identifies input port 208(4). Interface analyzer 103 stores output port 208(6), logic path 210(5), input port 208(5), input port 208(4), and the connectivities of these elements in the interface logic output. For module 202(3), interface analyzer 103 identifies input port 208(7) and input port 208(8) and stores these input ports 208 in interface logic output.

For module 202(4), interface analyzer 103 identifies output port 208(9), logic path 210(8), and storage element 206(8). Interface analyzer 103 also identifies output port 208(10), logic path 210(9), and storage element 206(9). Interface analyzer 103 also identifies output port 208(11), logic path 210(10), and storage element 206(10). Interface analyzer 103 stores these identified elements as well as the connectivity therebetween in interface logic output. For module 202(5), interface analyzer 103 identifies output port 208(14), input port 208(12), and input port 208(13). Because port 208(14) is an output port, interface analyzer 103 also follows logic path 210(11) and determines that logic path 210(11) is coupled to input port 208(12). Interface analyzer 103 stores these elements and the connectivity therebetween in interface logic output.

Interface analysis is now described for the working model 300 depicted in FIG. 3. For module 202(1) in working model 300, interface analyzer 103 writes the same elements to interface logic output as with module 202(1) in standard model 200, since module 202(1) is the same in both standard model 200 and working model 300. For module 202(2) in working model 300, interface analyzer 103 writes only input port 208(4) into interface logic output, since this port 208 is an input port 208. For module 202(3) in working model 300, interface analyzer 103 writes the same elements to interface logic output as with module 3 202(3) in standard model 200, since module 202(3) is the same in both standard model 200 and working model 300.

For module 202(4) in working model 300, interface analyzer 103 writes the same elements to interface logic output as with module 202(4) in standard model 200. Additionally, interface analyzer 103 identifies input port 208(15), output port 208(16), and logic path 210(13) as well as the connectivities therebetween, and stores these elements and connectivities to the interface logic output. For module 5 202(5) in the working model 300, interface analyzer 103 identifies output port 208(18), output port 208(14), input port 208(17), input port 208(12), and input port 208(13). Interface analyzer 103 also identifies logic path 210(14), logic path 210(16), and storage element 206(12). Interface analyzer 103 stores these elements and the connectivities therebetween to interface logic output.

In a second mode of operation, interface analyzer 103 performs interface analysis in a manner similar to the first mode of operation, but adjusts for elements referred to as “retiming registers.” A retiming register is a storage element 206 that is added to a microchip representation to adjust timing behavior associated with the microchip representation. In some situations, when a path between two storage elements located in different modules 202 is particularly long, the gate delay between those two storage elements 206 may exceed a single clock cycle. In such situations, one or more retiming registers are added to the microchip representation between the two storage elements in such a way that the gate delay before, between, and after the retiming registers is less than one clock cycle. Although the number of retiming registers along a path typically exactly match between the standard model and working model to preserve correct circuit operation, the retiming registers are often located in different modules in the working model as compared to the standard model to improve timing based on actual physical distances and pathways between the modules.

In the second mode of operation, interface analyzer 103 is configured to recognize retiming registers and to include logic paths beyond such retiming registers. More specifically, if in a particular module 202 the interface analyzer 103 is tracing back through the module 202 from an output port 208, then when the interface analyzer 103 encounters a retiming register, or a chain of retiming registers, the interface analyzer 103 does not stop at the retiming register(s), but instead proceeds backwards through logic paths 210 in the module 202 to either another storage element 206 or an input port 208. Moreover, the interface analyzer 103 includes the retiming register(s) in the interface logic output, and also includes the logic gates from the output port 208 to the retiming register(s) and from the retiming register(s) to the input port 208.

The second mode of operation is now described with reference to the example standard model 200 and working model 300. The interface analyzer 103 determines that no retiming registers exist in the standard model and therefore stores the same elements and connectivities in interface logic output as with in the first mode for the standard model 200. However, when analyzing the working model 300, the interface analyzer 103 determines that storage element 206(12) is a retiming register. Therefore, interface analyzer 103 includes storage element 206(12) in the interface logic output. Further, interface analyzer 103 continues to trace logic path 210(15) and determines that logic path 210(15) is connected to input port 208(12). Therefore, interface analyzer 103 also stores these elements and corresponding connectivities in interface logic output. Interface analyzer 103 stores the remainder of working model 300 in interface logic output in the same manner as with the first mode. This particular example would reveal a mismatch in retiming register count to the designers, so that designers could correct the mismatch to restore proper circuit operation.

In a third mode of operation, interface analyzer 103 is configured to include logic paths 210 that extend from certain input ports 208 to storage elements 206 within the module 202 in addition to analyzing the logic paths 210 that extend from the output ports 208. More specifically, when interface analyzer 103 is analyzing an input port 208, interface analyzer 103 examines a logic path 210 that extends from that input port 208 to determine whether the logic path 210 extends to either one storage element 206 within the module 202 or more than one storage element 206 within the module 202. If the logic path 210 extends to only one storage element 206 within the module 202, then interface analyzer 103 includes the input port 208, the logic path 210, and the storage element 206 in the interface logic output. If the logic path 210 extends to more than one storage element 206 within the module 202, then interface analyzer 103 only includes the input port 208 in the interface logic output. The third mode of operation allows interface analyzer 103 to include additional logic in the interface logic output, as compared with the first mode of operation, which may allows for fewer false negatives to occur.

The third mode of operation is now described with reference to the example standard model 200 and working model 300. For both standard model 200 and working model 300, the interface analyzer 103 stores the same elements as stored by the basic mode. However, for module 202(2) of both the working model 200 and the standard model 300, interface analyzer 103 also determines that logic path 201(4) from input port 208(4) extends to only one storage element 206(5) and stores logic path 210(4) and storage element 206(5) as well as associated connectivities in interface logic output. For module 202(1) of both the working model 200 and the standard model 300, interface analyzer 103 determines that logic path 210(3) extends to more than one storage element and therefore does not store logic path 210(3), storage element 206(2), or storage element 206(3) in interface logic output.

For module 202(3) of both the standard model 200 and the working model 300, interface analyzer 103 determines that logic path 210(6) from input port 208(7) and logic path 210(7) from input port 208(8) extend to a single storage element 206. Therefore, interface analyzer 103 stores logic path 210(6), logic path 210(7), storage element 206(6), storage element 206(7), and associated connectivities in interface logic output. For module 204(5) of the working model 300, interface analyzer 103 determines that logic path 210(12) from input port 208(13) extends to a single storage element 206(11) and stores input port 208(13), logic path 210(12), and storage element 206(11) and associated connectivities in interface logic output.

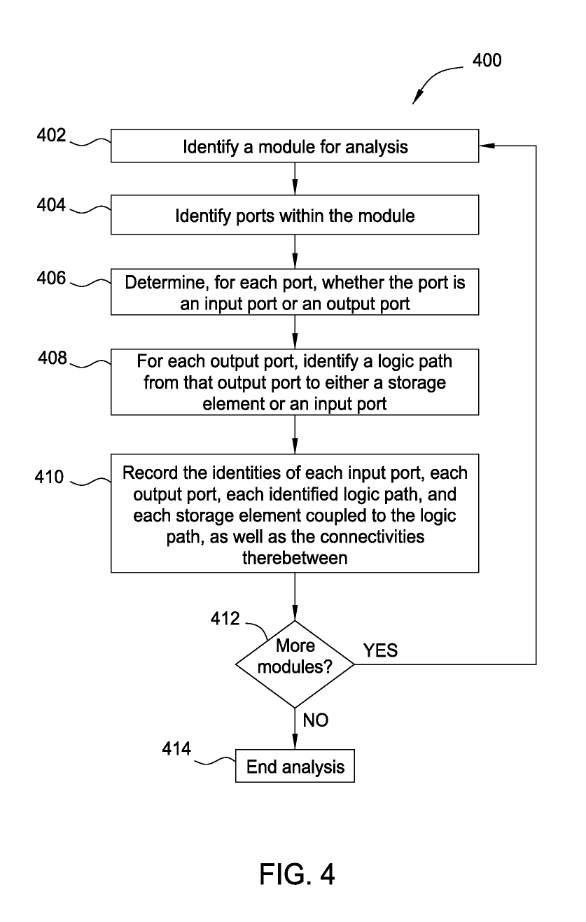

FIG. 4 is a flow diagram of method steps for performing interface analysis, according to one embodiment of the present invention. Although the method steps are described in conjunction with FIGS. 1-3, persons skilled in the art will understand that any system configured to perform the method steps, in any order, falls within the scope of the present invention.

As shown, a method 400 begins in step 402, where the interface analyzer 103 identifies a module 202 of a microchip representation for interface analysis. In step 404, the interface analyzer 103 identifies ports 208 within the module 202. The ports may include both input ports and output ports. In step 406, the interface analyzer 103 determines, for each port 208, whether the port 208 is an input port 208 or an output port 208. In step 408, the interface analyzer 103 identifies, for each output port 208, a logic path 210 from that output port 208 to either a storage element 206 or an input port. In a second mode of operation, interface analyzer 103 recognizes retiming registers and includes the retiming registers, tracing the logic path 210 back further to either a storage element 206 or an input port 208. In step 410, the interface analyzer 103 records the identities of each input port 208, each output port 208, each identified logic path 210, and each storage element 206 coupled to the logic path 210, as well as the connectivities therebetween. In a third mode of operation, interface analyzer 103 includes logic paths 210 that extend between input ports 208 and a single storage element 206 in the module. In step 412, the interface analyzer 103 determines whether there are more modules 202 to analyze. If there are more modules 202 to analyze, then the method returns to step 402. If there are no more modules 202 to analyze, then the method proceeds to step 414, in which the interface analyzer 103 ends the interface analysis.

In sum, an interface analyzer analyzes modules of a digital circuit representation. The interface analyzer identifies output ports and input ports in the modules. For each output port, the interface analyzer identifies each logic path that flows to the output port. For each logic path that flows from a storage element, the interface analyzer stops following the logic path and stores the logic path and storage element in an interface logic output. If a logic path flows to the output port from an input port, then the interface analyzer stores the output port, logic path, and input port in the interface logic output. For each input port, the interface analyzer stores the input port in the interface logic output. The union of all aforementioned stored elements comprises the interface logic output.

One advantage of the disclosed approach is that interface analyzer produces interface logic output that includes more information than just information about the ports between modules. Including such information allows formal verification to result in fewer false negatives than with techniques that only store ports in the interface logic output. With fewer false negatives, the time required for development is reduced. Another advantage is that less information is included in interface logic output than in some techniques that include more than just the ports within the modules, which reduces the amount of time required for formal verification. With reduced time required for formal verification, the time required for development is reduced.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

The invention claimed is:

1. A method for performing an interface analysis, the method comprising:
identifying a first module included in a representation of a digital circuit;
identifying a first output port associated with the first module;
identifying a first logic path that extends from the first output port;
determining that the first logic path extends to a first storage element included in the first module; and
including the first module, the first output port, the first logic path, and the first storage element in interface logic output data.

2. The method of claim 1, wherein the interface logic output data is stored as a gate-level netlist.

3. The method of claim 1, further comprising identifying a first input port of the first module that is an input port and including the first input port in the interface logic output data.

4. The method of claim 3, further comprising identifying a second logic path that extends from the first input port, and identifying a second storage element to which the second logic path extends.

5. The method of claim 4, further comprising determining that the second logic path extends only to the second storage element, and including the second logic path and the second storage element in the interface logic output data.

6. The method of claim 3, further comprising identifying a second output port, determining that the second output port is coupled to a third logic path, determining that the third logic path is coupled to the first input port without any intervening storage elements, and including the second output port and the third logic path in the interface logic output data.

7. The method of claim 3, further comprising:
identifying a second output port;
determining that the second output port is coupled to a third logic path;
determining that the third logic path is coupled to a retiming register without any intervening storage elements; and
including the retiming register and a fourth logic path coupled to the retiming register and to a second input port in the interface logic output.

8. The method of claim 1, further comprising determining that the first logic path extends to a power-gate clamping logic element, and including the power-gate clamping logic element in the interface logic output.

9. The method of claim 1, further comprising determining that the first storage element is a merged storage element, and demerging the merged storage element to generate at least two storage elements, wherein including the first storage element in the interface logic output data comprises including the at least two storage elements in the interface logic output data.

10. A non-transitory computer-readable medium for performing an interface analysis, the non-transitory computer-readable medium including instructions that, when executed by a processor, cause the processor to execute the steps of:
identifying a first module included in a representation of a digital circuit;
identifying a first output port associated with the first module;
identifying a first logic path that extends from the first output port;
determining that the first logic path extends to a first storage element included in the first module; and
including the first module, the first output port, the first logic path, and the first storage element in interface logic output data.

11. The non-transitory computer-readable medium of claim 10, wherein the interface logic output data is stored as a gate-level netlist.

12. The non-transitory computer-readable medium of claim 10, further including instructions that cause the processor to identify a first input port of the first module that is an input port and including the first input port in the interface logic output data.

13. The non-transitory computer-readable medium of claim 12, further including instructions that cause the processor to identify a second logic path that extends from the first input port, and identify a second storage element to which the second logic path extends.

14. The non-transitory computer-readable medium of claim 13, further including instructions that cause the processor to determine that the second logic path extends only to the second storage element, and include the second logic path and the second storage element in the interface logic output data.

15. The non-transitory computer-readable medium of claim 12, further including instructions that cause the processor to identify a second output port, determine that the second output port is coupled to a third logic path, determine that the third logic path is coupled to the first input port without any intervening storage elements, and include the second output port and the third logic path in the interface logic output data.

16. The non-transitory computer-readable medium of claim 12, further including instructions that cause the processor to:
identify a second output port;
determine that the second output port is coupled to a third logic path;
determine that the third logic path is coupled to a retiming register without any intervening storage elements; and
include the retiming register and a fourth logic path coupled to the retiming register and to a second input port in the interface logic output.

17. The non-transitory computer-readable medium of claim 10, further including instructions that cause the processor to determine that the first logic path extends to a power-gate clamping logic element, and include the power-gate clamping logic element in the interface logic output.

18. The non-transitory computer-readable medium of claim 10, further including instructions that cause the processor to determine that the first storage element is a merged storage element, and demerge the merged storage element to generate at least two storage elements, wherein including the first storage element in the interface logic output data comprises including the at least two storage elements in the interface logic output data.

19. A system for performing an interface analysis, the system comprising:
an interface analyzer configured to:
identify a first module included in a representation of a digital circuit;
identify a first output port associated with the first module;
identify a first logic path that extends from the first output port;
determine that the first logic path extends to a first storage element included in the first module; and
include the first module, the first output port, the first logic path, and the first storage element in interface logic output data.

20. The interface analyzer of claim 19, wherein the interface logic output data is stored as a gate-level netlist.
